(19) United States
(12) Patent Application Publication
(10) Pub. No.: US 2010/0320835 A1
(43) Pub. Date: Dec. 23, 2010

(54) DEVICE FOR OPERATING A VEHICLE

(75) Inventors: Michael Meinert, Erlangen (DE); Karsten Rechenberg, Dormitz (DE)

Correspondence Address: HARNESS, DICKEY & PIERCE, P.L.C., P.O.BOX 8910, RESTON, VA, 20195, US

(73) Assignee: Siemens AG, Munich (DE)

(21) Appl. No.: 12/816,456

(22) Filed: Jun. 16, 2010

(30) Foreign Application Priority Data
Jun. 18, 2009 (DE) 10 2009 025 477.3

(51) Int. Cl. B60L 1/00

(52) U.S. Cl. 307/9.1

(57) ABSTRACT

A device for operating a vehicle, in particular a rail vehicle, is disclosed. In at least one embodiment, an energy feed device is connected to a drive device via a drive rectifier, and to an energy store via an energy storage rectifier. In at least one embodiment, there is provision that the energy storage rectifier can be reconfigured. Its output is connected to the energy store and to the drive device via switches, with the result that the energy storage rectifier can be connected to the drive device instead of to the energy store.

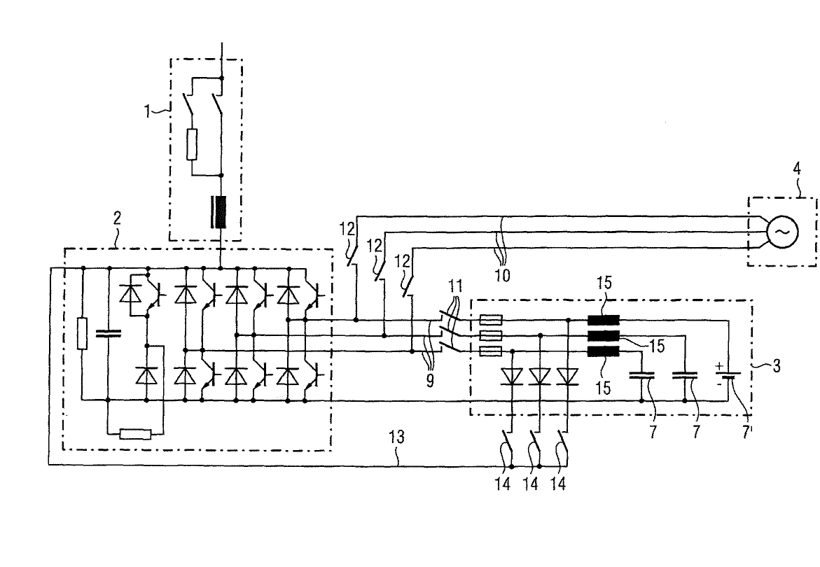

### PRIORITY STATEMENT

The present application hereby claims priority under 35 U.S.C. §119 on German patent application number DE 10 2009 025 477.3 filed Jun. 18, 2009, the entire contents of which are hereby incorporated herein by reference.

### FIELD

At least one embodiment of the invention generally relates to a device for operating a vehicle, in particular a rail vehicle, wherein an energy feed device is connected to a drive device via a drive rectifier, and/or to an energy store via an energy storage rectifier.

### BACKGROUND

A vehicle may be an electrically driven, track-guided vehicle, but it may also be an electrically driven road vehicle, for example a bus or a truck.

Particularly in a small electrically driven vehicle which has an intermediate circuit, but also in a large vehicle, it is customary to supply electrical energy to the drive device, that is to say the motors, via drive rectifiers-frequently just one or two thereof.

It is also customary that in such a vehicle an energy store is provided for the storage and later use of energy, for example the energy which is produced during the braking in a generator mode. An energy storage rectifier is connected upstream of such an energy store. Such an energy storage rectifier generally has the same power requirements as a drive rectifier.

If a fault occurs in the drive rectifier in such a known device, the vehicle cannot be operated at all anymore, or only in a highly restricted way, depending on the type of fault.

### SUMMARY

In at least one embodiment of the invention, a device is specified for operating a vehicle in which, even when the drive rectifier has failed, the vehicle can continue to operate.

According to at least one embodiment of the invention, the energy storage rectifier can be reconfigured, and/or its output is connected to the energy store and to the drive device via switches in order to connect the energy storage rectifier to the drive device instead of to the energy store.

According to at least one embodiment of the invention, an advantage is obtained in that, if the drive rectifier fails or is disrupted, the still functionally capable energy storage rectifier can be connected immediately to the drive device in order to ensure the continued operation of the vehicle.

The reconfiguring of the energy storage rectifier ensures that instead of operating as a multiple-section DC/DC controller for the energy store, the energy storage rectifier operates as a power inverter for the drive unit. While the energy store has to be provided with direct current, the drive device requires alternating current.

Both the energy store and the drive device are connected via feed lines to the output of the energy storage rectifier, wherein switches in these feed lines are always switched in such a way that either the energy store or the drive device is connected. In this context, the energy store is separated and the drive device is connected if the energy storage rectifier is reconfigured.

In at least one embodiment, an advantage may be obtained in that the energy storage rectifier can, when necessary, immediately replace a drive rectifier, with the result that even if a drive rectifier fails, the continued operation of the vehicle is always ensured.

For example, in order to supply energy from the energy store, the latter is connected to the input of the energy storage rectifier via switches.

This provides the advantage that when the energy feed device does not supply sufficient electrical energy and the energy storage rectifier is intended to supply the drive device, the energy which is stored in the energy store can be fed directly to the energy storage rectifier and thus to the drive device.

The energy store is switched as an energy source, for example, parallel to the intermediate circuit capacitor of the energy storage rectifier.

For example, in the energy store chopper inductors which serve as decoupling inductors are connected upstream of each of the storage capacitors which are provided and of each of the storage batteries which are provided.

For example, at least one storage capacitor which is provided and/or at least one storage battery of the energy store are connected to the input of the energy storage rectifier via a switch.

This switch is closed only when the energy storage rectifier is intended to replace a drive rectifier. The direct voltage which is provided at the at least one storage capacitor acts as a signal which triggers the reconfiguration of the energy storage rectifier. The switch closes if, for example, the intermediate circuit voltage drops below the energy storage voltage, and opens if the intermediate circuit voltage rises above the maximum permissible energy storage voltage. Furthermore, it serves for additionally supplying energy to the energy storage rectifier, and therefore to the drive device.

The device for operating a vehicle according to at least one embodiment of the invention provides, in particular, the advantage that an energy storage rectifier which is provided in any case can replace a disrupted or even failed drive rectifier.

The device can be used in electrically driven vehicles with direct current drive, three-phase current drive or alternating current drive.

The availability of the vehicle is increased with the device, and in a vehicle with just one drive rectifier it is doubled.

### BRIEF DESCRIPTION OF THE DRAWINGS

An example embodiment of the device for operating a vehicle according to the invention will be explained in more detail with reference to a drawing:

The drawing shows an energy feed device 1 which is connected via an energy storage rectifier 2 to an energy store 3.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The drawing shows an energy feed device 1 which is connected via an energy storage rectifier 2 to an energy store 3. So that the energy storage rectifier 2 can replace a drive rectifier (not shown) which is not functionally capable, the energy storage rectifier 2 must be reconfigured in such a way that it does not operate as a multiple-section DC/DC controller, which is required to charge the energy store 3, but rather as a power inverter which generates three-phase current or alternating current and which is suitable for supplying a drive device 4.

The energy storage rectifier 2 is connected on the output side to the energy store 3 via first feed lines 9, and to the drive device 4 via second feed lines 10. First switches 11 are located in the first feed line 9, and second switches 12 are located in the second feed line 10. An internal control unit (not shown) of the energy storage rectifier 2 is used for the reconfiguration. For the reconfiguration, the first switches 11 are opened, the energy storage rectifier 2 is reprogrammed, the data records for the power inverter operating mode are loaded and the second switches 12 are subsequently closed.

In order to supply additional energy to the drive device from the energy store 3, which is necessary if the energy supply from the energy feed device 1 is not sufficient, the energy store 3 is connected to the input of the energy storage rectifier 2 via a supply line 13 in which a third switch 14, which is embodied with three poles, is located. The third switch 14 is closed when there is an additional energy requirement, when the intermediate circuit voltage of the energy storage rectifier has dropped below the energy storage voltage.

In the energy store 3 chopper inductors 15, which serve as decoupling inductors, are arranged upstream of each of the storage capacitors 7 which are provided and the storage battery 7′ which is provided.

With the device according to at least one embodiment of the invention it is possible, when necessary, to use the energy storage rectifier 2 to supply the drive device 4.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for operating a vehicle, comprising:
an energy feed device, connected to a drive device via a drive rectifier, and connected to an energy store via an energy storage rectifier, the energy storage rectifier being reconfigurable and an output of the energy storage rectifier being connected to the energy store and to the drive device, via switches, in order to connect the energy storage rectifier to the drive device instead of to the energy store.

2. The device as claimed in claim 1, wherein, in order to supply energy from the energy store, the energy store is connected to an input of the energy storage rectifier via at least one switch.

3. The device as claimed in claim 2, wherein at least one of at least one storage capacitor and at least one storage battery of the energy store is connected to the input of the energy storage rectifier via the at least one switch.

4. The device as claimed in claim 3, wherein the at least one storage battery of the energy store is connected to the input of the energy storage rectifier via a decoupling diode.

5. The device as claimed in claim 1, wherein the device is for operating a rail vehicle.
